(19) United States
(12) Patent Application Publication
(10) Pub. No.: US 2008/0031254 A1
(43) Pub. Date: Feb. 7, 2008

(54) Two-pronged receive fragment processing in a wireless network

(76) Inventor: Satish Kumar Veerapuneni, Hillsboro, OR (US)

Correspondence Address: The Law Offices of John C. Scott, LLC;c/o Intellevate, P.O. Box 52050, Minneapolis, MN, 55402, US

(21) Appl. No.: 11/500,147

(22) Filed: Aug. 7, 2006

(51) Int. Cl. H04L 12/56

(52) U.S. Cl. 370/394; 370/473

(57) ABSTRACT

During a receive fragment reassembly procedure, two separate reassembly operations may be active at the same time. One operation may be used to track fragments that are received in-sequence, while the other operation may be initiated when a first fragment is received out-of-sequence. By supporting two separate reassembly operations concurrently, situations may be avoided where data is lost due to the receipt of an erroneous out-of-sequence first fragment.

### TECHNICAL FIELD

The invention relates generally to wireless communication and, more particularly, to techniques for fragmenting and reassembling messages being transmitted through a wireless channel.

### BACKGROUND OF THE INVENTION

In a wireless network, larger data units may sometimes be broken up into smaller data units before they are transmitted through a wireless link to increase the efficiency with which the available bandwidth is utilized. After reception, the smaller data units may be reassembled into the corresponding larger data units. This process is known as fragmentation and reassembly. Techniques are needed for efficiently reassembling fragments in such systems in a manner that reduces the loss of valid fragments.

### BRIEF DESCRIPTION OF THE DRAWINGS

FIG. 1 is a block diagram illustrating an example wireless network arrangement in accordance with an embodiment of the present invention;

FIG. 2 is a diagram illustrating an example fragment in accordance with an embodiment of the present invention;

FIG. 3 is a diagram illustrating an example fragmentation sub-header in accordance with an embodiment of the present invention;

FIGS. 4, 5, and 6 are portions of a flowchart illustrating an example method for processing received fragments in a wireless network in accordance with an embodiment of the present invention; and

FIG. 7 is a flowchart illustrating an example method for performing a fragment sanity check in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

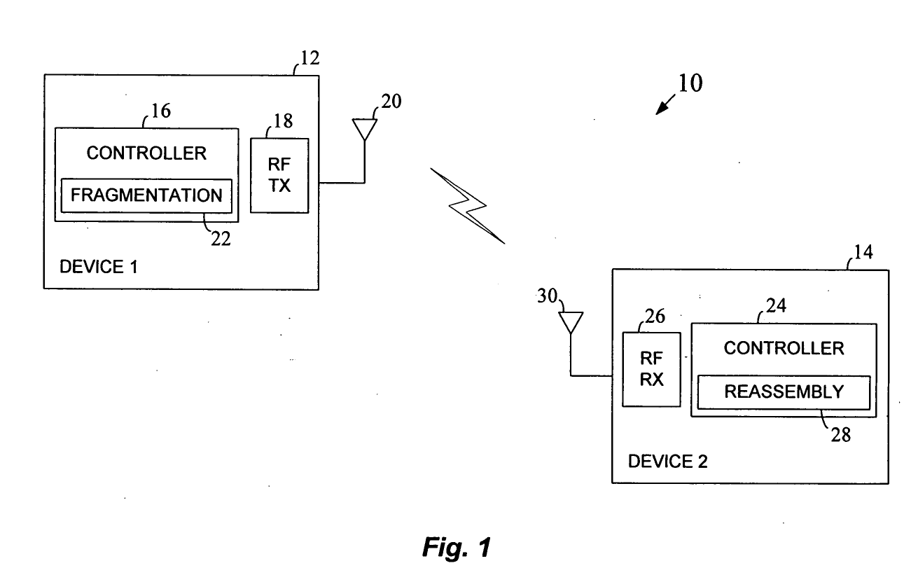

FIG. 1 is a block diagram illustrating an example wireless network arrangement 10 in accordance with an embodiment of the present invention. As shown, a first wireless device 12 is communicating with a second wireless device 14 through a wireless channel. The first and second wireless devices 12, 14 may each be any type of device that is capable of communicating via wireless link including, for example, a wireless client device (e.g., a laptop, palmtop, desktop, or tablet computer having wireless networking functionality, a personal digital assistant (PDA) having wireless networking functionality, a cellular telephone or other wireless handheld communicator, etc.), a wireless base station, a wireless access point, and/or others. When the first wireless device 12 transmits data to the second wireless device 14, it may divide up a medium access control (MAC) service data unit (SDU) into multiple MAC protocol data units (PDUs) before the data is transmitted into the channel, in a process known as fragmentation. Fragmentation may be performed to, for example, make more efficient use of the bandwidth resources allocated to the connection between the two devices 12, 14. After reception, the second wireless device 14 reassembles the fragments into an SDU for delivery to a corresponding application (executing within, for example, a host processor, etc.). A similar fragmentation and reassembly process may also occur when data is transmitted in the reverse direction from the second wireless device 14 to the first wireless device 12.

As shown in FIG. 1, the first wireless device 12 may include a controller 16 and a radio frequency (RF) transmitter 18. The controller 16 may perform some or all of the digital communication processing functions of the first wireless device 12. The RF transmitter 18 is operative for transmitting data received from the controller 16 into the wireless channel. The RF transmitter 18 may be coupled to one or more antennas 20 to facilitate the transmission of signals into the wireless channel. Any type of antenna(s) may be used including, for example, a dipole, a patch, a helical antenna, an antenna array, and/or others. The controller 16 may include fragmentation logic 22 for performing fragmentation of data units before transmission. As discussed above, fragmentation typically involves breaking up a larger data unit into one or more smaller data units, known as fragments. After fragmentation, the controller 16 may cause the fragments to be independently transmitted into the wireless channel via RF transmitter 18 and antenna 20.

The second wireless device 14 may include a controller 24 and a radio frequency (RF) receiver 26. The controller 24 may perform some or all of the digital communication processing functions of the second wireless device 14. The RF receiver 26 is operative for receiving signals from the wireless channel that were transmitted by a remote entity. The RF receiver 26 may then process the received signals to convert them to a baseband representation. The RF receiver 26 may be coupled to one or more antennas 30 to facilitate the reception of signals from the wireless channel. Any type of antenna(s) may be used including, for example, a dipole, a patch, a helical antenna, an antenna array, and/or others. The controller 24 may include reassembly logic 28 for reassembling fragments received from a remote wireless entity (e.g., first wireless device 12) into corresponding SDUs. The controller 24 may then cause the reassembled SDUs to be delivered to a corresponding application being executed within the second wireless device 14 (within, for example, a host processor, etc.).

The controller 16 within the first wireless device 12 and the controller 24 within the second wireless device 14 may each be implemented using, for example, one or more digital processing devices. The digital processing device(s) may include, for example, a general purpose microprocessor, a digital signal processor (DSP), a reduced instruction set computer (RISC), a complex instruction set computer (CISC), a field programmable gate array (FPGA), an application specific integrated circuit (ASIC), a microcontroller, and/or others, including combinations of the above. Although illustrated as a transmitting device and a receiving device, it should be appreciated that the first and second wireless devices 12, 14 will both typically be capable of supporting bi-directional communication. The first and second wireless devices 12, 14 will each typically follow one or more wireless communication standards such as, for example, IEEE 802.11, IEEE 802.16, HiperLAN 1,2, HomeRF, Bluetooth, and/or others. One or more cellular wireless standards may also, or alternatively, be supported.

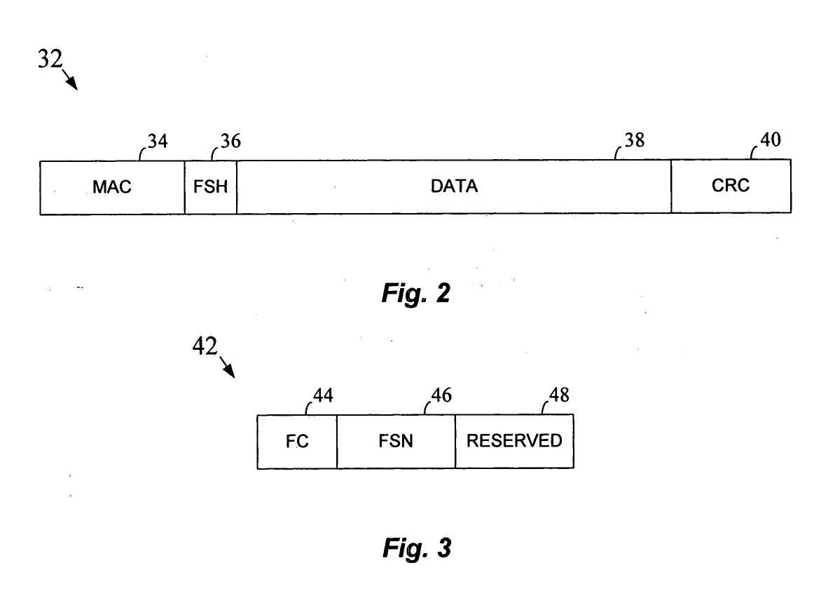

FIG. 2 is a diagram illustrating an example fragment 32 in accordance with an embodiment of the present invention. As shown, the fragment 32 may include a generic MAC header 34, a fragmentation sub-header (FSH) 36, payload data 38, and an optional cyclic redundancy check (CRC) value 40. The MAC header 34 carries descriptive information about the fragment 32 and may include one or more of: a CRC indicator (CI) to indicate whether a CRC is present, a connection identifier (CID) to identify the connection to which the fragment is associated, one or more encryption related fields, a header check sequence (HCS) for use in detecting errors in the header, a header type (HT), a length (LEN) indicating a length in bytes of the MAC PDU, and a type field to indicate that a fragmentation sub-header is present. The FSH 36 is included at the start of the payload of the fragment 32 and further describes the fragment. The data 38 is the fragmented data from the corresponding SDU. The CRC 40 may be used to determine whether there are errors in the fragment 32 after the fragment 32 has propagated through the channel.

FIG. 3 is a diagram illustrating an example FSH 42 in accordance with an embodiment of the present invention. The FSH 42 may be used, for example, within the fragment 32 of FIG. 2. As shown, the FSH 42 includes a fragment control (FC) value 44 and a fragment sequence number (FSN) 46. The FSH 42 also includes a reserved field 48 for future use. The FC 44 identifies whether the corresponding fragment is a first fragment, a middle fragment, or a last fragment of a corresponding SDU. In at least one embodiment, the FC 44 may also indicate whether the fragment 32 is an unfragmented data unit. Example values for the FC 44 may include the following:

| Fragment Type | FC |
|---|---|
| First Fragment | 10 |
| Middle Fragment | 11 |
| Last Fragment | 01 |
| Unfragmented | 00 |

There may be more than one middle fragment in a particular SDU fragmentation. Other formats for expressing the FC may alternatively be used. The FSN 46 is a fragment sequence number that increases by one for each successive fragment transmitted by a transmitting device to a receiving device. The FSNs of the fragments may be used by the receiving device to reassemble the received fragments into SDUs in the appropriate order. The FSNs assigned by a transmitting device to transmitted fragments may be assigned in a cyclical manner. That is, the transmitting device may start with an FSN of zero for a first fragment and then increment this by one for each subsequent fragment up to some fixed value (e.g., 2¹¹, etc.), after which the FSN cycles back to zero and starts increasing again.

The IEEE 802.16 wireless networking standard defines an automatic repeat request (ARQ) mechanism that allows blocks to be automatically retransmitted if they are lost or corrupted in transit. The ARQ mechanism uses acknowledgement (ACK) messages and a sliding window approach to track unsuccessfully received blocks. The IEEE 802.16 standard makes the ARQ mechanism an optional feature. When implemented, the ARQ mechanism may be enabled on a per connection basis. Fragmentation may be used in both ARQ-enabled and non-ARQ connections. The techniques of the present invention, when implemented within an IEEE 802.16 based network, are for use with non-ARQ connections in an open channel. The inventive techniques may also be used with other wireless standards. That is, any wireless system that uses fragmentation and that assigns both a fragment control (FC) type value and a fragment sequence number (FSN) to each transmitted fragment may benefit by incorporating features of the present invention.

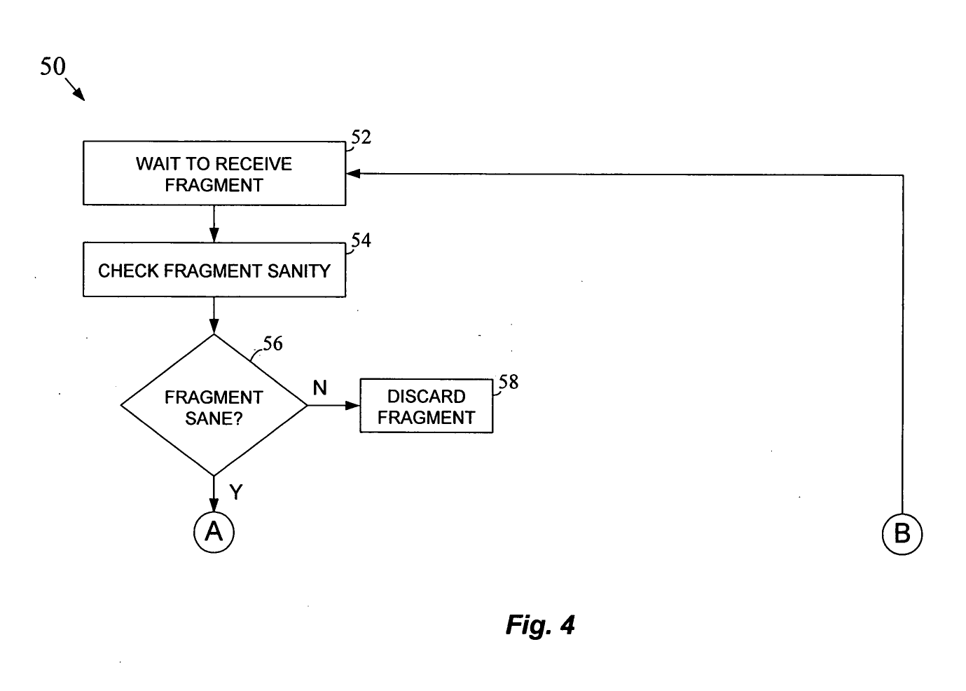

FIGS. 4, 5, and 6 are portions of a flowchart illustrating an example method 50 for processing received fragments in a wireless network in accordance with an embodiment of the present invention. The method 50 may be implemented within, for example, the reassembly logic 28 of FIG. 1. In previous fragment processing techniques, when an out-of-sequence fragment is received that is tagged as a “first fragment,” any SDU reassembly operation that is already in progress is abandoned in favor of the newly received fragment. However, in some cases, an out-of-sequence fragment may be received that is bogus. This can lead to a situation where a valid SDU reassembly operation is abandoned based on a bogus fragment, resulting in an unnecessary loss of data. In accordance with at least one embodiment of the present invention, two different SDU reassembly operations may be tracked concurrently during a reassembly procedure, one for in-sequence fragments and another for situations where an out-of-sequence fragment is received. In this manner, situations may be avoided where data is lost due to receipt of an erroneous out-of-sequence fragment, thus enhancing throughput in the network. In the discussion that follows, the term SIP1 (SDU-in-progress 1) will be used to refer to an SDU reassembly data structure that processes in-sequence fragments and the term SIP2 (SDU-in-progress 2) will be used to refer to an SDU reassembly data structure that processes fragments that follow the receipt of an out-of-sequence first fragment.

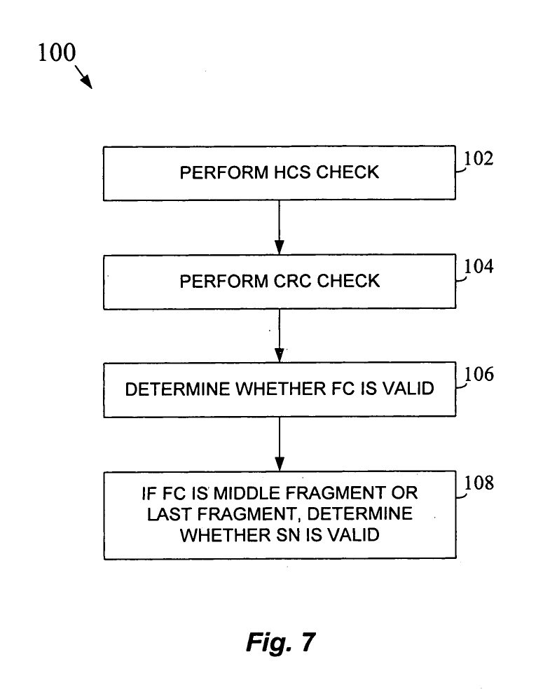

With reference to FIG. 4, a receiving device initially waits for receipt of a fragment (block 52). When a fragment is received, the sanity of the fragment is first checked (block 54). The sanity check is performed to determine whether the fragment qualifies for further processing. FIG. 7 is a flowchart illustrating an example method 100 for performing a sanity check for a received fragment in accordance with an embodiment of the present invention. As shown, an HCS check may first be performed to determine whether there are any errors in the header of the fragment (block 102). A CRC check may also be performed to determine whether there are errors in the fragment as a whole (block 104). The FC that is indicated in the fragmentation sub-header of the fragment may next be checked to determine whether it is a valid FC (e.g., first fragment, middle fragment, last fragment, unfragmented) (block 106). If the received fragment is identified as a middle or last fragment, it may next be determined whether the SN of the fragment is valid (block 108). The SN of the fragment may be deemed valid if it is one unit greater than the SN of a last fragment associated with either SIP1 or SIP2. The fragment may be considered sane if all of the above-described tests are passed. Other sanity check sequences may alternatively be used.

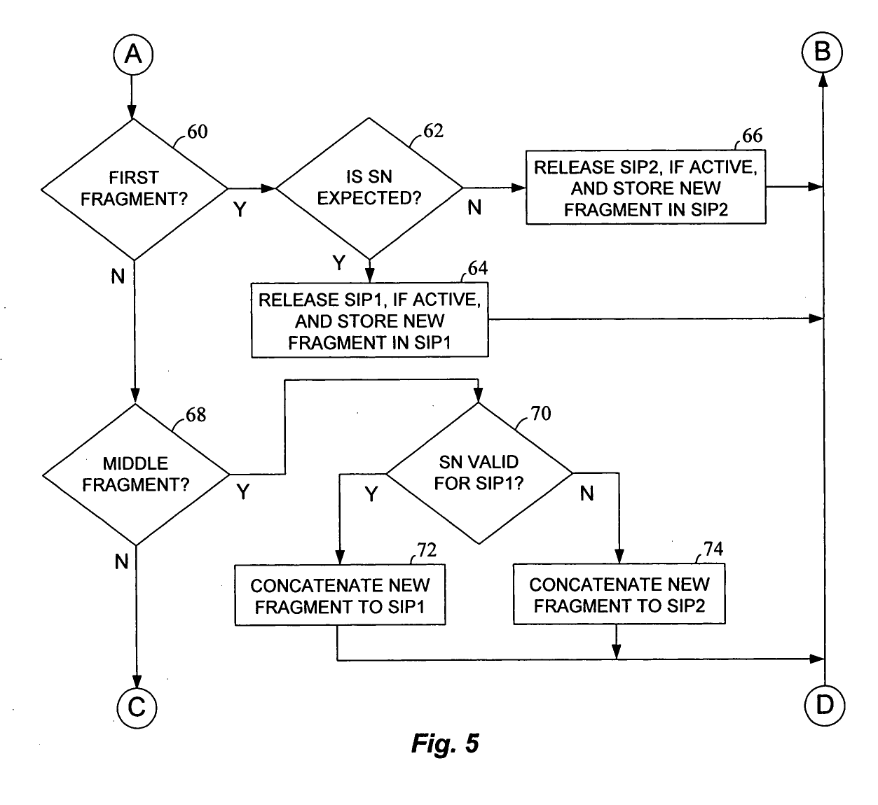

Referring back to FIG. 4, if the fragment fails the sanity check (block 56-N), it may be discarded (block 58). If the fragment passes the sanity check (block 56-Y), the subsequent processing will depend upon the FC of the fragment. If the fragment is a “first fragment” (FIG. 5, block 60-Y), it is next determined whether the SN of the fragment is expected (block 62). The SN of the fragment is expected if it is 1 unit higher than the SN of a most recently received fragment (i.e., it is in-sequence). If the SN of the fragment is expected (block 62-Y), then SIP1 is released (if it is currently active) and the new fragment is stored in SIP1 (block 64). If the SN of the fragment is not expected (block 62-N), then SIP2 is released (if it is currently active) and the new fragment is stored in SIP2 (block 66). Thus, SIP2 is used whenever a first fragment is received out-of-sequence and SIP 1 is used whenever a first fragment is received in-sequence. After either block 64 or block 66 has been performed, the method 10 may return to block 52 to wait for a next fragment to be received for the connection's service flow (or to process a next fragment that was received and stored).

If the current fragment is not a first fragment (block 60-N), it is next determined whether the fragment is a middle fragment (block 68). If the current fragment is a middle fragment (block 68-Y), then it is known that the SN of the fragment is valid because the fragment passed the sanity check. However, as discussed previously, the SN of the fragment can be valid with respect to either SIP1 or SIP2. If the SN is valid for SIP1 (block 70-Y), then the fragment is concatenated to SIP1 (block 72). If the SN is valid for SIP2 (block 70-N), then the fragment is concatenated to SIP2 (block 74). After either block 72 or block 74 has been performed, the method 10 may return to block 52 to wait for a next fragment to be received for the connection's service flow (or to process a next fragment that was received and stored).

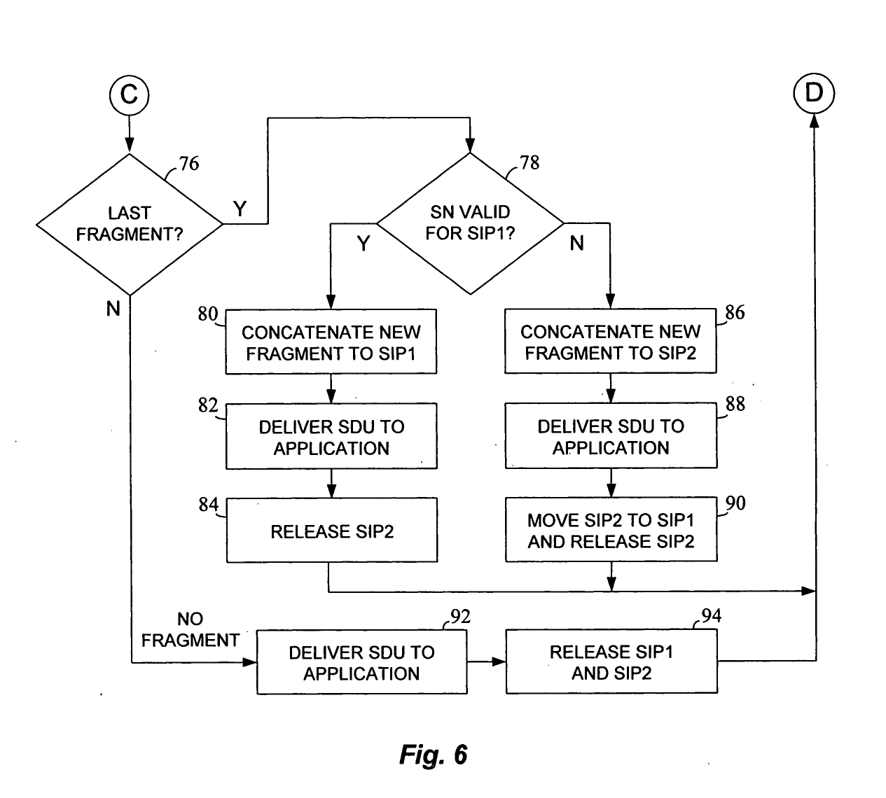

If the current fragment is not a middle fragment (block 68-N), it is next determined whether the fragment is a last fragment (FIG. 6, block 76). If the current fragment is a last fragment (block 76-Y), then it is known that the SN of the fragment is valid because the fragment passed the sanity check. As before, the SN of the fragment may be valid for either SIP1 or SIP2. If the SN is valid for SIP1 (block 78-Y), then the current fragment may be concatenated to SIP1 (block 80). Because this is a last fragment, this concatenation completes the reassembly of an SDU. The reassembled SDU may then be delivered to the corresponding application (block 82). Because the last fragment is associated with SIP1, it may be assumed that the reassembly operation being tracked by SIP2 is bogus. Both SIP1 and SIP2 may therefore be released at this time (i.e., nulled) (block 84).

If the SN of the current fragment is valid for SIP2 (block 78-N), then the fragment is concatenated to SIP2 (block 86). The reassembled SDU from SIP2 is then delivered to the corresponding application (block 88). Because the last fragment is associated with SIP2, it may be assumed that the reassembly operation being tracked by SIP1 is bogus. Both SIP1 and SIP2 may therefore be released (block 90). After either block 84 or block 90 has been performed, the method 10 may return to block 52 to wait for a next fragment to be received for the connection's service flow (or to process a next fragment that was received and stored).

If the current fragment is not a last fragment (block 76-N), then the FC of the fragment has to be “unfragmented” in the illustrated embodiment. Thus, the fragment is a complete SDU in itself. The method 10 may therefore deliver the SDU to the corresponding application (block 92). SIP1 and SIP2 may then be released (block 94). The method 10 may then return to block 12 to wait for a next fragment to be received for the connection's service flow (or to process a next fragment that was received and stored).

As an example of the operation of the above-described method, assume that fragments having SNs 1, 2, 3, 4, and 5 have just been received in order by a receiver.

Further assume that the fragment having SN 3 was a first fragment and the fragments having SNs 4 and 5 were middle fragments. Therefore, SIP1 would have the fragment having SN 3 stored therein with the fragments having SNs 4 and 5 concatenated thereto.

Now assume that the next fragment received is a first fragment having a SN of 13. This SN is not expected, so SIP2 is released (if it is active) and the new fragment is stored in SIP 2. There are now two different SDU reassembly operations in progress, one of which is bogus. The subsequent processing may detect which of the two operations is bogus.

If the next received fragment is a middle fragment having a SN of 6, then the new fragment will be concatenated to SIP1 because the SN of the new fragment is one unit higher than the SN of the fragment most recently processed in SIP1. If, on the other hand, the next received fragment is a middle fragment having a SN of 14, then the new fragment will be concatenated to SIP2 because the SN of the new fragment is one unit higher than the SN of the fragment most recently processed in SIP2. If, instead of a middle fragment, the next received fragment is a last fragment that has a SN of 6, then the new fragment will be concatenated to SIP1, the resulting SDU will be delivered to the corresponding application, and SIP2 will be released. SIP2 is released because it is assumed at this point that the reassembly operation being tracked by SIP2 is bogus. If, on the other hand, the next received fragment is a last fragment with a SN of 14, then the new fragment will be concatenated to SIP2, the resulting SDU will be delivered to the application, the contents of SIP2 will be transferred to SIP1, and SIP2 will be released. In this instance, it is assumed that the reassembly operation being tracked by SIP1 is bogus.

In the above-described embodiment, it is assumed that the reassembly operation being tracked by one of the data structures (SIP1 and SIP2) is bogus when a last fragment is concatenated to the other data structure. In another possible approach, it may also be assumed that the reassembly operation being tracked by one of the data structures (SIP1 and SIP2) is bogus when a middle fragment is concatenated to the other data structure. Thus, when a middle fragment is received and is concatenated to SIP1, SIP2 may be released (if active). Similarly, when a middle fragment is received and is concatenated to SIP2, the contents of SIP2 may be transferred to SIP1 and SIP2 may be released.

The procedures and structures of the present invention may be implemented in any of a variety of different forms. For example, features of the invention may be embodied within laptop, palmtop, desktop, and tablet computers having wireless capability; personal digital assistants (PDAs) having wireless capability; cellular telephones and other handheld wireless communicators; pagers; satellite communicators; cameras having wireless capability; audio/video devices having wireless capability; computer peripherals having wireless capability; network interface cards (NICs) and other network interface structures; base stations; wireless access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data. As used herein, the term “logic” may include, by way of example, software or hardware and/or combinations of software and hardware.

It should be appreciated that the individual blocks illustrated in the block diagrams herein may be functional in nature and do not necessarily correspond to discrete hardware elements. For example, in at least one embodiment, two or more of the blocks in a diagram are implemented in software within a common digital processing device. The digital processing device may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, including combinations of the above. Hardware, software, firmware, and hybrid implementations may be used.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method comprising:
receiving a fragment of a service data unit (SDU) from a wireless channel, said fragment being a current fragment, said current fragment including: (a) a sequence number (SN) identifying a position of said current fragment within a fragment sequence assigned by a transmitting device and (b) an indication of whether said current fragment is a first fragment, a middle fragment, or a last fragment of said SDU; and
when said current fragment is a first fragment, determining whether to store said current fragment in a first data structure or a second data structure based on whether said SN of said current fragment is expected, wherein said SN of said current fragment is expected if it is one unit higher than a SN of a fragment that was most recently received from said wireless channel prior to receipt of said current fragment.

2. The method of claim 1, further comprising:
when a determination is made to store said current fragment in said first data structure, nulling said first data structure and then storing said current fragment in said first data structure; and
when a determination is made to store said current fragment in said second data structure, nulling said second data structure an d storing said current fragment in said second data structure.

3. The method of claim 1, further comprising:
when said current fragment is a middle fragment, determining whether to concatenate said current fragment to said first data structure or said second data structure based on said SN of said current fragment.

4. The method of claim 3, wherein:
determining whether to concatenate said current fragment to said first data structure or said second data structure includes determining whether said SN of said current fragment is one unit higher than a SN of a fragment most recently processed in said first data structure or one unit higher than a SN of a fragment most recently processed in said second data structure.

5. The method of claim 3, further comprising:
when a determination is made to concatenate said current fragment to said first data structure, concatenating said current fragment to said first data structure and nulling said second data structure; and
when a determination is made to concatenate said current fragment to said second data structure, concatenating said current fragment to said second data structure, transferring the contents of said second data structure to said first data structure, and nulling said second data structure.

6. The method of claim 1, further comprising:
when said current fragment is a last fragment, determining whether to concatenate said current fragment to said first data structure or said second data structure based on said SN of said current fragment.

7. The method of claim 6, further comprising:
when a determination is made to concatenate said current fragment to said first data structure, concatenating said current fragment to said first data structure, delivering a reassembled SDU from said first data structure to a corresponding application, and nulling said first and second data structures; and
when a determination is made to concatenate said current fragment to said second data structure, concatenating said current fragment to said second data structure, delivering a reassembled SDU from said second data structure to a corresponding application, and nulling said first and second data structures.

8. The method of claim 1, wherein:
said indication within said current fragment can also indicate that said current fragment is an unfragmented SDU; and
said method further comprises delivering said current fragment to a corresponding application and nulling said first and second data structures when said current fragment is an unfragmented SDU.

9. The method of claim 1, further comprising:
performing a sanity check on said current fragment after said current fragment is received but before said current fragment is further processed; and
terminating processing of said current fragment when said fragment fails said sanity check;
wherein performing a sanity check includes determining, when said current fragment is a middle fragment or a last fragment, whether said SN of said current fragment is valid, wherein said SN of said current fragment is valid when it is either: (a) one unit higher than a SN of a fragment most recently processed in said first data structure or (b) one unit higher than a SN of a fragment most recently processed in said second data structure.

10. An apparatus comprising:
a fragment reassembler to process a current fragment received from a wireless channel, said current fragment including (a) a sequence number (SN) identifying a position of said current fragment within a fragment sequence assigned by a transmitting device and (b) an indication of whether said current fragment is a first fragment, a middle fragment, or a last fragment of a corresponding SDU, wherein said fragment reassembler includes logic to determine, when said current fragment is a first fragment, whether to store said current fragment in a first data structure or a second data structure based on whether said SN of said current fragment is expected, wherein said SN of said current fragment is expected if it is one unit higher than a SN of a fragment that was most recently received from said wireless channel prior to receipt of said current fragment.

11. The apparatus of claim 10, wherein:
said fragment reassembler further includes: (a) logic to null said first data structure and then store said current fragment in said first data structure when a determination is made to store said current fragment in said first data structure; and (b) logic to null said second data structure and then store said current fragment in said second data structure when a determination is made to store said current fragment in said second data structure.

12. The apparatus of claim 10, wherein:
said fragment reassembler further includes logic to determine whether to concatenate said current fragment to said first data structure or said second data structure, based on said SN of said current fragment, when said current fragment is a middle fragment.

13. The apparatus of claim 12, wherein:
said logic to determine whether to concatenate said current fragment to said first data structure or said second data structure includes logic to determine whether said SN of said current fragment is one unit higher than a SN of a fragment most recently processed in said first data structure or one unit higher than a SN of a fragment most recently processed in said second data structure.

14. The apparatus of claim 12, wherein:
said fragment reassembler further includes:
logic to concatenate said current fragment to said first data structure and null said second data structure when a determination is made to concatenate said current fragment to said first data structure; and
logic to concatenate said current fragment to said second data structure, transfer contents of said second data structure to said first data structure, and null said second data structure when a determination is made to concatenate said current fragment to said second data structure.

15. The apparatus of claim 10, wherein:
said fragment reassembler further includes logic to determine whether to concatenate said current fragment to said first data structure or said second data structure, based on said SN of said current fragment, when said current fragment is a last fragment.

16. The apparatus of claim 15, wherein:
said fragment reassembler further includes:
logic to concatenate said current fragment to said first data structure, deliver a reassembled SDU from said first data structure to a corresponding application, and null said first and second data structures when a determination is made to concatenate said current fragment to said first data structure; and
logic to concatenate said current fragment to said second data structure, deliver a reassembled SDU from said second data structure to a corresponding application, and null said first and second data structures when a determination is made to concatenate said current fragment to said second data structure.

17. The apparatus of claim 10, wherein:
said indication within said current fragment can also indicate that said current fragment is an unfragmented SDU;
wherein said fragment reassembler further includes logic to deliver said current fragment to a corresponding application and null said first and second data structures, when said current fragment is an unfragmented SDU.

18. The apparatus of claim 10, wherein:
said fragment reassembler further includes:
logic to perform a sanity check on said current fragment after said current fragment is received but before said current fragment is further processed; and
logic to terminate processing of said current fragment when said fragment fails said sanity check;
wherein said logic to perform a sanity check includes logic to determine, when said current fragment is a middle fragment or a last fragment, whether said SN of said current fragment is valid, wherein said SN of said current fragment is valid when it is either: (a) one unit higher than a SN of a fragment most recently processed in said first data structure or (b) one unit higher than a SN of a fragment most recently processed in said second data structure.

19. An article comprising a storage medium having instructions stored thereon that, when executed by a computing platform, operate to:
obtain an SDU fragment that was received from a wireless channel, said SDU fragment being a current fragment, said current fragment including (a) a sequence number (SN) identifying a position of said current fragment within a fragment sequence generated by a transmitting device and (b) an indication of whether said current fragment is a first fragment, a middle fragment, or a last fragment of a corresponding SDU; and
determine, when said current fragment is a first fragment, whether to store said current fragment in a first data structure or a second data structure based on whether said SN of said current fragment is expected, wherein said SN of said current fragment is expected if it is one unit higher than a SN of a fragment that was most recently received from said wireless channel prior to receipt of said current fragment.

20. The article of claim 19, wherein said instructions further operate to:
determine whether to concatenate said current fragment to said first data structure or said second data structure, based on said SN of said current fragment, when said current fragment is a middle fragment.

21. The article of claim 19, wherein said instructions further operate to:
determine whether to concatenate said current fragment to said first data structure or said second data structure, based on said SN of said current fragment, when said current fragment is a last fragment;
concatenate said current fragment to said first data structure and deliver a reassembled SDU from said first data structure to a corresponding application when a determination is made to concatenate said current fragment to said first data structure; and
concatenate said current fragment to said second data structure and deliver a reassembled SDU from said second data structure to a corresponding application when a determination is made to concatenate said current fragment to said second data structure.

23. A system comprising:
at least one dipole antenna to receive a fragment of an SDU from a wireless channel, said fragment being a current fragment, said current fragment including (a) a sequence number (SN) identifying a position of said current fragment within a fragment sequence assigned by a transmitting device and (b) an indication of whether said current fragment is a first fragment, a middle fragment, or a last fragment of said SDU;
an RF receiver to convert said current fragment to a baseband representation; and
a fragment reassembler to process said current fragment, said fragment reassembler including logic to determine, when said current fragment is a first fragment, whether to store said current fragment in a first data structure or a second data structure based on whether said SN of said current fragment is expected, wherein said SN of said current fragment is expected if it is one unit higher than a SN of a fragment that was most recently received from said wireless channel prior to receipt of said current fragment.

24. The system of claim 23, wherein:
said fragment reassembler further includes logic to determine whether to concatenate said current fragment to said first data structure or said second data structure, based on said SN of said current fragment, when said current fragment is a middle fragment.

25. The system of claim 23, wherein:
said fragment reassembler further includes logic to determine whether to concatenate said current fragment to said first data structure or said second data structure, based on said SN of said current fragment, when said current fragment is a last fragment.

26. The system of claim 25, wherein:
said fragment reassembler further includes:
logic to concatenate said current fragment to said first data structure and deliver a reassembled SDU from said first data structure to a corresponding application when a determination is made to concatenate said current fragment to said first data structure; and
logic to concatenate said current fragment to said second data structure and deliver a reassembled SDU from said second data structure to a corresponding application when a determination is made to concatenate said current fragment to said second data structure.
